(19) United States
(12) Patent Application Publication
(10) Pub. No.: US 2009/0292757 A1
(43) Pub. Date: Nov. 26, 2009

(54) Method and apparatus for zero prediction

(76) Inventor: Steven Leeland, Scottsdale, AZ (US)

Correspondence Address: HENNEMAN & ASSOCIATES, PLC, 70 N. MAIN ST., THREE RIVERS, MI, 49093, US

(21) Appl. No.: 12/154,678

(22) Filed: May 23, 2008

(51) Int. Cl. G06F 7/50; G06F 7/48

(52) U.S. Cl. 708/524; 708/200; 708/671

(57) ABSTRACT

A zero prediction method and apparatus for use in a reduced instruction set computer. The zero predictor 115 in use is connected by a controller 110 to an arithmetic unit 120. Different embodiments of the invention for use in addition include inverters 205 connected via incrementers 220 to comparators 235 for subtraction and comparators 235 for decrementation. The method includes determination 915 of which arithmetic operation to be performed, activation 925, 950 and 975 of a suitable zero prediction method for the operation along with the operation subtraction 930, addition 955 and decrementation 980. If a zero is detected, operations 930, 955 and 980 are deactivated.

### FIELD OF INVENTION

This invention pertains to computing systems. In particular, this invention pertains to the arithmetic logic unit of a Reduced Instruction Set Computer (RISC) which incorporates simultaneous execution of different operations of complex calculations.

### BACKGROUND OF THE INVENTION

High speed processing systems can be achieved by using logic and fundamental arithmetic operations at a fast speed while reducing the complexity. The processing systems designed using RISC methodologies achieve high speeds by executing most of the instructions in one instruction cycle and at the same time reducing the circuitry required to manage instructions of different lengths. However, the time taken for executing different arithmetic operations can vary significantly in length of execution; for example, time taken to execute an arithmetic operation to increment is considerably less than time taken to execute an operation such as (A+B)/C*D. Thus, if both the above-described operations have to be performed in the same instruction cycle, the instruction cycle would be fairly large.

To overcome this limitation posed to the throughput of the processing system, it has been suggested to reduce the time taken to execute complex operations by portioning the complex operation into multiple operations and executing multiple operations in parallel. For example, the processor can execute both A+B and C*D operations at the same time and even determine if the value of the multiplication of C and D is equal to zero. In this scenario, where the product of C and D is used as a denominator in successive division, zero detection forms a critical timing path. If the processing system detects that the product of C and D will be a zero, then it can stop executing the operation rather than dividing with a zero.

### SUMMARY OF THE INVENTION

The proposed invention performs the zero prediction at a much faster rate than the arithmetic operation itself, so that the Arithmetic logic unit can operate at a higher processing speed.

The zero detection circuit of the invention is useful in many cases such as, but not limited to, when the sum of two numbers is going to be used as denominator in the subsequent division or if the difference of A and B is used to multiply with another value C. Traditional arithmetic unit designs first perform the arithmetic function and then test the result for Zero. That requires a serial accumulation of execution throughput delay. Extremely high speed is achieved using the parallel prediction approach of performing the arithmetic operation and the Zero result prediction in parallel. One proposed system performs zero prediction in parallel to the addition, but fails to optimize the zero prediction process. This system performs the zero prediction by comparing one of the input with negative value of the other input. Even though zero prediction is performed in parallel, the zero prediction might take the same amount of time as the arithmetic operation and thus may not be able to halt the arithmetic operation. For example, if the zero is predicted earlier than the arithmetic operation, in certain situations it is more beneficial to halt the arithmetic operation to save time and power, rather than performing the arithmetic operation.

### BRIEF DESCRIPTION OF THE FIGURES

FIG. 1 is a system level block diagram of a processor incorporating the invention.

FIG. 2 is a block diagram of the invention for use when two binary numbers are added.

FIG. 3 is a block diagram of the invention for use when binary numbers are decremented.

FIG. 4 is a block diagram of the invention for use when two binary numbers are subtracted.

FIG. 5a is a block diagram of the 7 bit comparator block of the invention.

FIG. 5b is a block diagram of the 7 bit inverter block of the invention.

FIG. 6 is a block diagram of the n bit Incrementer the invention. 10 FIG. 7 is a block diagram of the n bit Negater of the invention.

FIG. 8 is a block diagram of the n bit Adder of the invention.

FIG. 9 is a flow chart of the method of the invention.

### DETAILED DESCRIPTION OF THE FIGURES

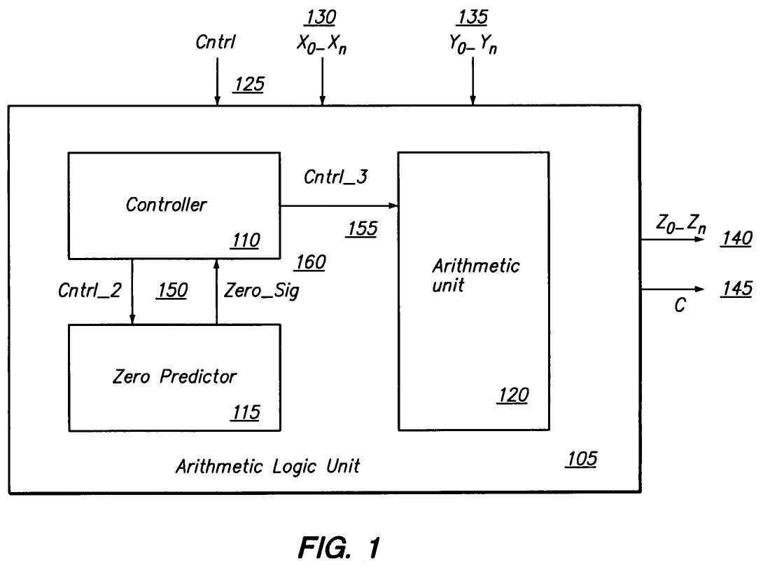

FIG. 1 is a system level block diagram of a processor incorporating the invention. In FIG. 1, an arithmetic logic unit (ALU) 105 is shown according to one embodiment of the invention. The device comprises a controller 110, Zero predictor 115, and an arithmetic unit 120. The arithmetic logic unit 105 receives a control signal cntrl 125 and performs arithmetic operations on input X₀-Xₙ 130 and Y₀-Yₙ 135 and can generate multiple outputs which can be represented as Outputs Z₀-Zₙ 140, and C 145. The controller 110, on receiving the control signal cntrl 125, determines the arithmetic operation that needs to be performed and activates both the arithmetic unit 120 and the zero predictor 115 using the activation signals cntrl_2 150 and cntrl_3 155, respectively. Zero predictor 115 will notify the controller 110 on determining if a zero is predicted or not using the control signal zero_sig 160. If a zero is predicted, then the controller 110 deactivates the arithmetic unit 120 using the control signal cntrl_2 120. On the other hand, if a zero is not predicted, the arithmetic operation being performed by the arithmetic unit 120 is completed to generate the output.

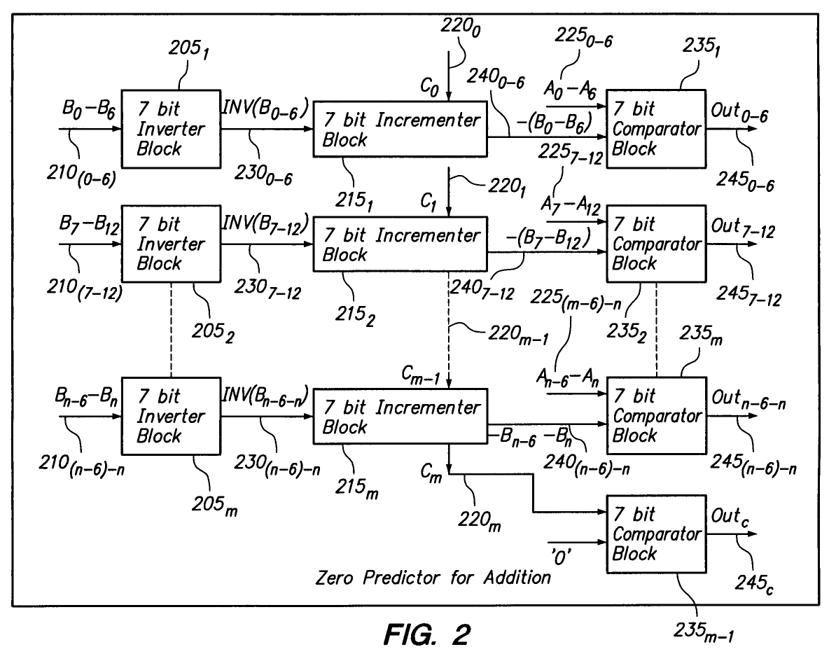

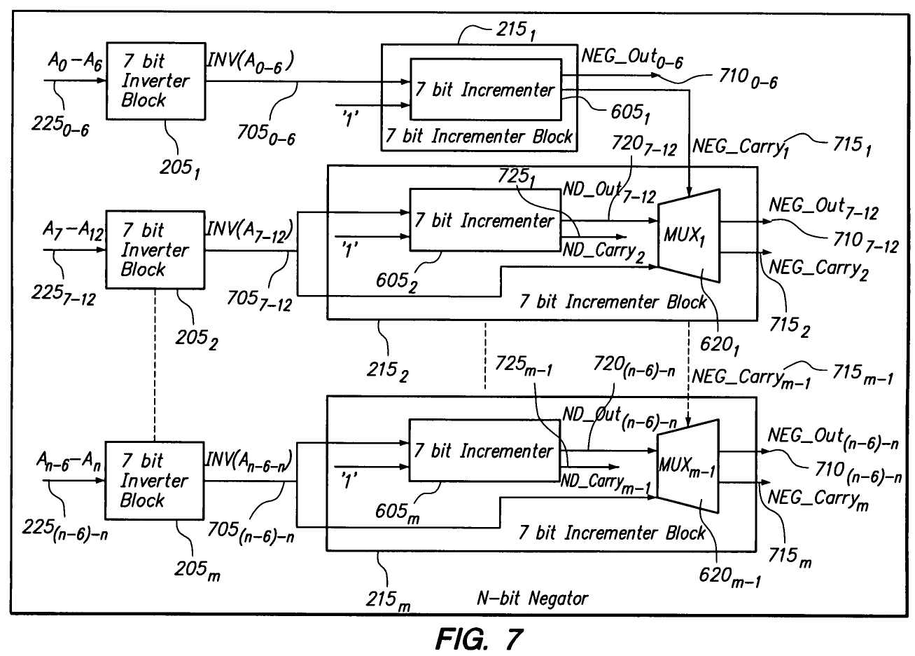

FIG. 2 is a block diagram of the invention for use when two binary numbers are added. In this embodiment, zero predictor 115 predicts if the sum of two binary numbers, A₀-Aₙ (225₀₋₆, 225₇₋₁₂ and 225ₙ₋₆₋ₙ) and B₀-Bₙ (210₀₋₆, 210₇₋₁₂ and 210ₙ₋₆₋ₙ) is zero. Zero predictor 115 compares one of the binary numbers with the two's complement of the other binary number, if both values are the same a zero output is predicted, otherwise a zero is not predicted. As shown in FIG. 2, the zero predictor 115 comprises a series of 7 bit inverters (205₁, 205₂₋205ₘ) connected in parallel, series of 7 bit incrementers (215₁, 215₂₋215ₘ) connected in parallel and also a series of 7 bit comparators (235₁, 235₂₋235ₘ) connected in parallel to allow for faster computations. Zero predictor 115 computes the two's complement of one of the binary input (in this case shown in FIG. 2)—(B₀-Bₙ) (235₀₋₆, 235₇₋₁₂ and 235ₙ₋₆₋ₙ) is obtained by first obtaining the inverted value of binary input, INV(B₀-Bₙ) (230₀₋₆, 230₇₋₁₂ and 230ₙ₋₆₋ₙ) and incrementing the inverted value by using the series of 7 bit incrementers (215₁, 215₂₋215ₘ) connected in parallel. The first 7 bit incrementer 215₁ accepts the 7 least significant bits of the inverted output INV(B₀-B₆) 230₀₋₆ and carry input C₀ 220₀ (the value of C₀ is ‘1’) and generates the output—(B₀-B₆ ) 240₀₋₆ and the carry bit C₁ 220₁ and the process is further carried out until all the n bits of the—(B₀-Bₙ) 240₀₋ₙ are computed. The operation of the n-bit incrementer is explained in further detail in FIG. 6. Once the two's complement value—(B₀-Bₙ) 240₀₋ₙ is computed, the binary values of A₀-A_{n (}225₀₋₆, 225₇₋₁₂ and 225ₙ₋₆₋ₙ) and—(B₀-Bₙ) (240₀₋₆, 240₇₋₁₂ and 240ₙ₋₆₋ₙ) are compared using the series of 7-bit comparators (235₁, 235₂₋235ₘ, 235ₘ₊₁) connected in parallel. The comparator output of each of the 7 bit comparators (235₁, 235₂₋235ₘ, 235ₘ₊₁), Out₀₋₆, Out₇₋₁₂ and Out_{n-6-n (}245₀₋₆, 245₇₋₁₂, 245ₙ₋₆₋ₙ), and Out_{c} 245_{c} are all compared with zeros and if the values are equal to zero then zero is predicted, otherwise non zero value is predicted.

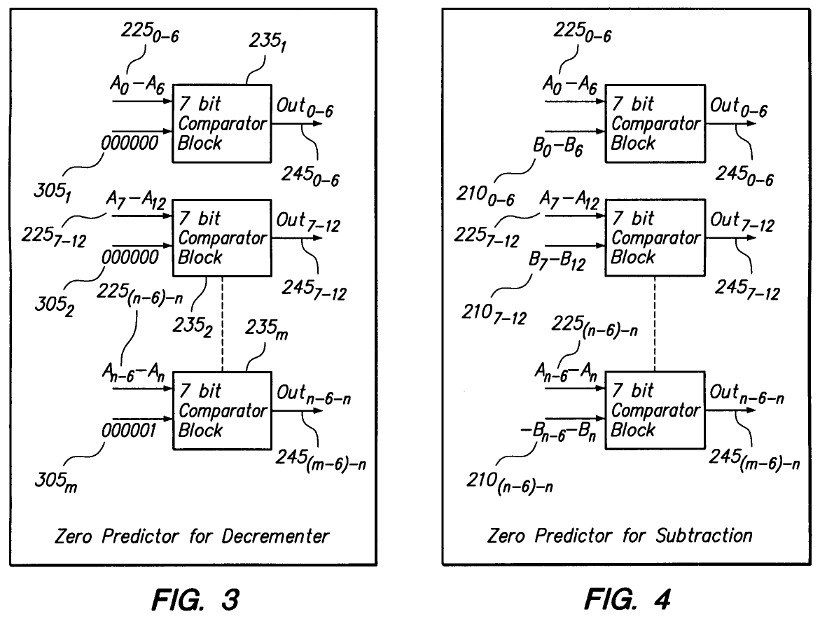

FIG. 3 is a block diagram of the invention for use when binary numbers are decremented. It is used where in the arithmetic operation that needs to be performed by the arithmetic logic unit is decrementing a binary input A₀-Aₙ (225₀₋₆, 225₇₋₁₂ and 225ₙ₋₆₋ₙ). In this embodiment, zero predictor 115 compares the value of the binary number, A₀-Aₙ(225₀₋₆, 225₇₋₁₂ and 225ₙ₋₆₋ₙ) and n-bit binary value of ‘1’ ₍305₀₋₆, 305₇₋₁₂ and 305ₙ₋₆₋ₙ). If the input value is equal to ‘1’ a zero output is predicted, otherwise a zero is not predicted. As in the earlier case, the comparison is carried by a series of 7-bit comparators (235₁, 235₂₋235ₘ) connected in parallel and the outputs of the comparators Out₀₋₆, Out₇₋₁₂ and Outₙ₋₆₋ₙ (245₀₋₆, 245₇₋₁₂ and 245ₙ₋₆₋ₙ) are compared with zeros and if the values are equal to zero then zero is predicted, otherwise non zero value is predicted.

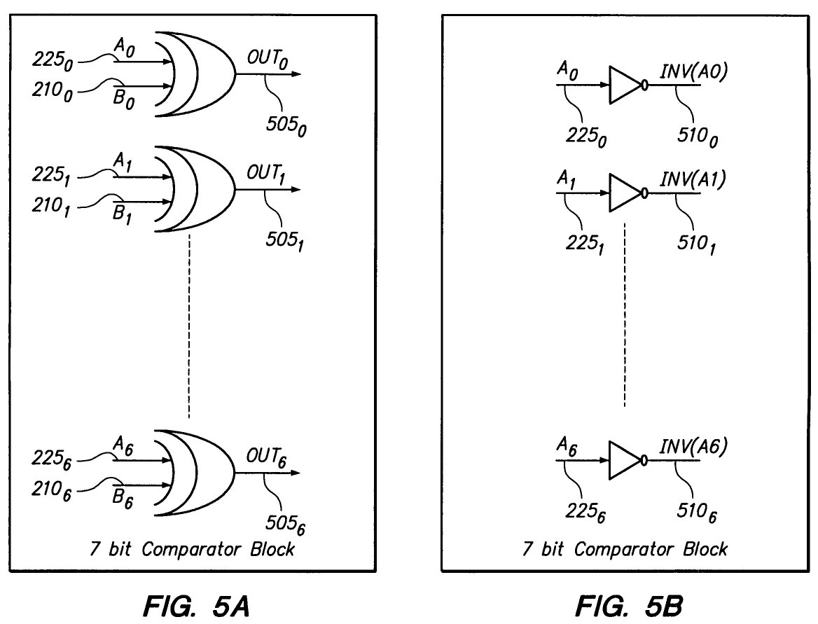

FIG. 4 is a block diagram of the invention for use when two binary numbers are subtracted. This is used where in the arithmetic operation that needs to be performed by the arithmetic logic unit is subtraction on two binary inputs. In this embodiment, zero predictor 115 predicts if the difference of two binary numbers, A₀-Aₙ(225₀₋₆, 225₇₋₁₂ and 225ₙ₋₆₋ₙ) and B₀-B_{n (}210₀₋₆, 210₇₋₁₂ and 210ₙ₋₆₋ₙ) is zero. The binary values of A₀-A_{n (}225₀₋₆, 225₇₋₁₂ and 225ₙ₋₆₋ₙ) and B₀-Bₙ) (210₀₋₆, 210₇₋₁₂ and 210ₙ₋₆₋ₙ) are compared using the series of 7-bit comparators (235₁, 235₂₋235ₘ) connected in parallel. The comparator output of each of the 7 bit comparators (235₁, 235₂₋235ₘ), Out₀₋₆, Out₇₋₁₂ and Out_{n-6-n (}245₀₋₆, 245₇₋₁₂ and 245ₙ₋₆₋ₙ) are compared with zeros and if the values are equal to zero then zero is predicted, otherwise non-zero value is predicted.

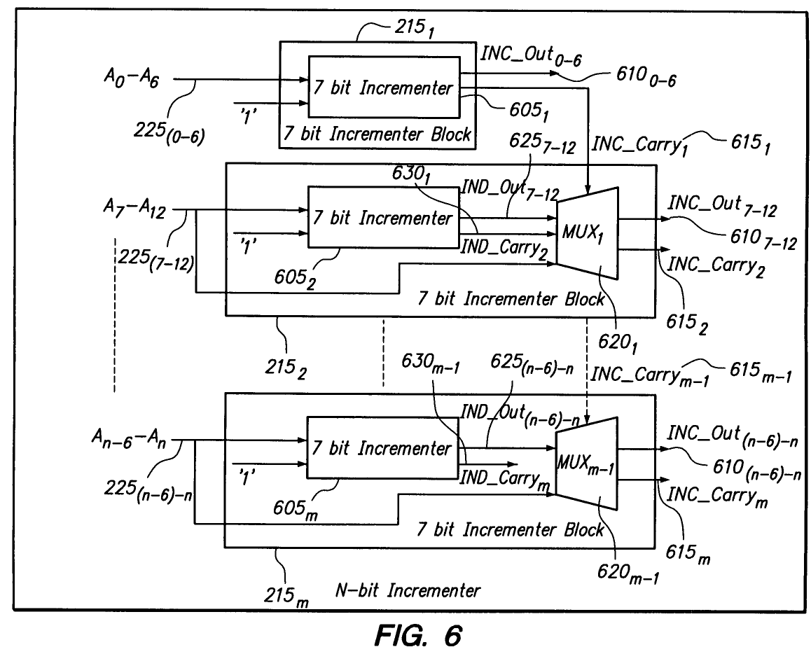

FIG. 5a is a block diagram of the 7 bit comparator block of the invention. In this embodiment of the 7 bit comparator 235₁ the seven least significant bits (LSB) of the two binary numbers, A₀-A_{6 (}225₀₋₆) and B₀-B_{6 (}210₀₋₆₎ are compared. The 7 bit comparator 235₁ compares the LSB input bits, A₀ with B₀, A₁ with B₁ through A₆ with B₆ respectively at the same time by using seven XOR gates in parallel. If the input bit A₀ is equal to the input B₀, then the output bit Out₀ is equal to ‘0’, otherwise the output bit Out₀ is equal to ‘1’.

FIG. 5b is a block diagram of the 7 bit inverter block of the invention, and depicts an embodiment of the 7 bit inverter 205₁ which inverts the logical value of the seven least significant bits (LSB) of the binary input, A₀-A_{6 (}225₀₋₆). The 7 bit inverter 205₁ inverts the logical state of the input bits, A₀, A₁ through A₆ at the same time by using seven inverters connected in parallel. If the input bit A₀ is at a logical state of ‘0’, then the output bit will be equal to ‘1’, otherwise the output bit will be a ‘0’.

FIG. 6 is a block diagram of the n bit Incrementer of the invention and illustrates an embodiment of the n-bit incrementer where the n bit input is incremented using a series of 7 bit incrementer blocks 215₁, 215₂ and 215ₙ connected in parallel. The first 7 bit incrementer block consists of a 7 bit incrementer 615₁ which receives the seven least significant bits (LSB) of the binary input A₀-A_{6 (}225₀₋₆) and increments with the value of ‘1’ and generates the incremented output INC_Out_{0-6 (}610₀₋₆) and carry bit INC_Carry₁ 615₁. The successive incrementer blocks 215₂ through 215ₘ comprises a 7 bit incrementer 605₂, 605ₘ, and a multiplexer MUX₁ 620₁ through MUXₘ₋₁ 620ₘ₋₁ respectively. All the incrementer blocks (605₁, 605₂₋605ₘ) each receives 7 bits of the binary inputs A₀-A_{6 (}225₀₋₆), A₇-A_{12 (}225₇₋₁₂) and Aₙ₋₆-A_{n (}225₍ₙ₋₆₎₋ₙ) respectively, and calculate the incremented output and carry output of the 7 bits simultaneously to generate INC_Out_{0-6 (}610₀₋₆), INC_Carry₁ 615₁, INC_Out_{7-12 (}610₇₋₁₂), INC_Carry₂ 615₂, INC_Out_{(n-6)-n (}610(ₙ₋₆₎₋ₙ), and INC_Carryₘ₋₁ 615ₘ₋₁. The incrementer 605_{2,}-605ₘ increment the 7 bits of binary inputs A₇-A_{12 (}225₇₋₁₂) and Aₙ₋₆-A_{n (}225₍ₙ₋₆₎₋ₙ) assuming that the carry from the preceding block is a ‘1’. The 7 bit incrementers 605₂ and 605ₘ of the incrementer blocks generate the intermediate incremented outputs IND_Out_{7-12 (}625₇₋₁₂), IND_Carry₂ 630₂, IND_Out_{(n'6)-n} 625(ₙ₋₆₎₋ₙ), and IND_Carry_{m'1} 630ₘ₋₁ based on the assumption that the carry bit of the preceding adder block is a ‘1’, the multiplexers can't provide the output until the actual value of the carry bit is known. Thus, in the worst case situation, time taken to generate the output of n-bit incrementer is equal to the time taken by a 7 bit incrementer and time taken by the (m−1) multiplexers to identify and provide the output based on the carry bit of the incrementer block.

In another embodiment, the time taken by the n bit incrementer can be further reduced by predicting the value of carry bit of the preceding adder block. To predict the carry bit, the least significant bits (LSB) of the binary input of each incrementer block is verified, if the LSB is equal to ‘0’ then the carry bit will be a zero, and the multiplexer of the successive adder block can provide the output without waiting for the preceding adder block to generate the carry bit. For example, if the binary input A_{0 (}225₀) of the incrementer block 215₁ is a zero, the incrementer block 215₂ can provide the output at the same time as the incrementer block 215₁. Thus, if all of the LSB input of all of the incrementer blocks are zero, the time taken to generate the output of the n-bit incrementer can be reduced significantly to the time taken to generate the output of a 7-bit incrementer. In another embodiment, the seven bit incrementer used in the circuit can be designed using a minimal number of gates (using the Quine-Mccluskey algorithm the number of gates can be reduced significantly) and thus generating the incrementer output with a maximum of three gate delay.

FIG. 7 is a block diagram of the n bit Negater of the invention and illustrates an embodiment of the n-bit negater that can be utilized to obtain a two's complement of the n bit binary input. The n-bit input is first inverted using a series of 7 bit inverter blocks (205₁, 205₂₋205ₘ) connected in parallel and then incremented by a binary value of ‘1’ by a series of 7 bit incrementer blocks (215₁, 215₂₋215ₘ) connected in parallel. A series of 7 bit inverter blocks (205₁, 205₂₋205ₘ) inverts the binary input A₀-A_{6 (}225₀₋₆), A₇-A_{12 (}225₇₋₁₂) and A₁-A_{n (}225₍ₙ₋₆₎₋ₙ₎ to generate INV(A₀-A₆₎ 705₀₋₆, INV(A₇-A₁₂₎ 705₇₋₁₂ and INV(Aₙ₋₆-Aₙ₎ 705₍ₙ₋₆₎₋ₙ. The first 7 bit incrementer block consists of a 7 bit incrementer 615₁ which receives the seven least significant bits (LSB) of the binary input A₀-A_{6 (}225₀₋₆) and increments with the value of ‘1’ and generates the incremented output Neg_Out_{0-6 (}710₀₋₆) and carry bit Neg_Carry₁ 715₁. The successive incrementer blocks 215₂ through 215ₘ comprises a 7 bit incrementer 605₂, 605ₘ, and a multiplexer MUX₁ 620₁ through MUXₘ₋₁ 620_{m'1} respectively. All the incrementer blocks (605₁, 605₂₋605ₘ) each receives a 7 bits of the inverted binary inputs INV(A₀-A₆) 705₀₋₆, INV(A₇-A₁₂₎ 705₇₋₁₂ and INV(Aₙ₋₆-Aₙ₎ 705₍ₙ₋₆₎₋ₙ respectively, and calculate the incremented output and carry output of the 7 bits simultaneously to generate Neg_Out_{0-6 (}710₀₋₆), Neg_Carry₁ 715₁, Neg_Out_{7-12 (}710₇₋₁₂), Neg_Carry₂ 715₂, Neg_Out₍ₙ₋₆₎₋ₙ 710₍ₙ₋₆₎₋ₙ, and Neg_Carryₘ 715ₘ. The incrementers 605_{2,}-605ₘ increment the 7 bits of the inverted binary inputs INV(A₇-A₁₂₎ 705₇₋₁₂ and INV(Aₙ₋₆-Aₙ₎ 705_{(n-6 )-n} assuming that the carry from the preceding block is a ‘1’. The 7 bit incrementers 605₂ and 605ₘ of the incrementer blocks generate the intermediate values of incremented outputs and carry outputs ND_Out₁₍720₇₋₁₂), and carry ND_carry_{1 (}725₁) through ND_Outₘ₍720(ₙ₋₆₎₋ₙ), and carry ND_carry_{m-1 (}725ₘ₋₁) based on their own assumptions of the carry bit of the preceding adder blocks, the multiplexers can't provide the output until the actual value of the carry bit is known. Thus, in the worst case situation, time taken to generate the output of the n-bit incrementer is equal to the sum of time taken by a 7 bit inverter block, time taken by a 7 bit inverter block and time taken by the (m−1) multiplexers to identify and provide the output based on the carry bit of the incrementer block.

In another embodiment, the time taken by the n bit negater can be further reduced by predicting the value of carry bit of the preceding adder block. To predict the carry bit, the least significant bits (LSB) of the binary input of each incrementer block is verified, if the LSB is equal to ‘0’ then the carry bit will be a zero, and the multiplexer of the successive adder block can provide the output without waiting for the preceding adder block to generate the carry bit. For example, if the value of the inverted binary input A_{0 (}705₀) of the incrementer block 215₁ is a zero, the incrementer block 215₂ can provide the output at the same time as the incrementer block 215₁. Thus, if all of the LSB input of all of the incrementer blocks are zero then the time taken to generate the output of the n-bit negater can be reduced significantly to the sum of the time taken to generate the output of a 7-bit inverter and time taken to generate the output of a 7-bit incrementer.

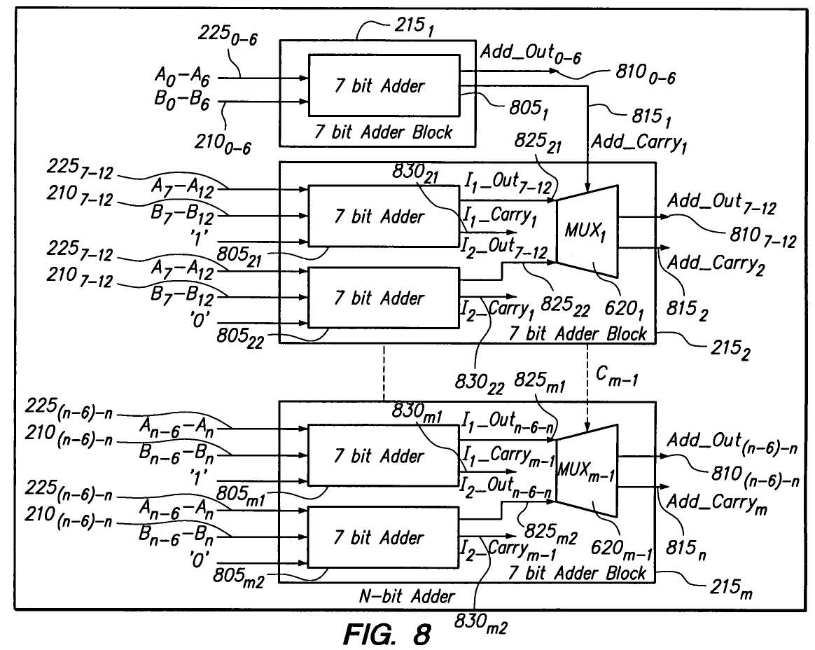

FIG. 8 is a block diagram of the n bit Adder of the invention that illustrates an embodiment of the n-bit adder that generates the sum of two binary inputs A₀-A_{6 (}225₀₋₆), A₇-A_{12 (}225₇₋₁₂) and Aₙ₋₆-A_{n (}225₍ₙ₋₆₎₋ₙ₎ and B₀-B_{6 (}210₀₋₆), B₇-B_{12 (}210₇₋₁₂) and B₀-B_{n (}210₍ₙ₋₆₎₋ₙ). The n-bit adder comprises a series of 7 bit adder blocks (805₁, 805₂₋805ₘ) connected in parallel. The adder blocks 805₂₋805ₘ further comprises two 7 bit adders 805₂₁, 805₂₂ and 805ₘ₁, 805ₘ₂ and a multiplexer MUX₁ 825₁ through MUXₘ 825ₘ₋₁ respectively. The adder blocks 805_{21,}-805ₘ₁ add the binary inputs assuming that the carry from the preceding block is a ‘1’ and the adder blocks 805_{22,}-805ₘ₂ add the binary inputs assuming that the carry from the preceding block is a ‘0’. All the adder blocks (805₁, 805₂₋805ₘ) each receives 7 bits of the binary inputs A₀-A_{6 (}225₀₋₆), A₇-A_{12 (}225₇₋₁₂) and Aₙ₋₆-Aₙ 225₍ₙ₋₆₎₋ₙ respectively, and calculate the sum of the 7 bits simultaneously to generate Add_Out₀₋₆ 810₀₋₆, Add_Carry₁ 815₁, Add_Out₇₋₁₂ 810_{7-12.} Add_Carry₂815₂, Add_Outₙ₋₆₋ₙ810₍ₙ₋₆₎₋ₙ, and Add_Carryₘ₋₁ 815ₘ. The adders 805₂₁, 805₂₂ and 805ₘ₁, 805ₘ₂ in the adder blocks generate the intermediate sums and carry bits based, I₁_{_{—}}Out₇₋₁₂ 825_{21,} I₁_{_{—}}Carry₁ 830_{11,} I₂_{_{—}}Out₇₋₁₂ 825_{21,} I₂_{_{—}}Carry₁ 830₁₂, I₁_{_{—}}Out₍ₙ₋₆₎₋ₙ 825ₘ₁, I₁_{_{—}}Carryₘ₋₁ 830_{m1,} I₂_{_{—}}Out₍ₙ₋₆₎₋ₙ 825_{m2,} I₂_{_{—}}Carry₁ 830_{m2,}. on their own assumptions of the carry bit of the preceding adder blocks, the multiplexers can't provide the output until the actual value of the carry bit is known. Thus, in the worst case situation, time taken to generate the output of n-bit adder is equal to the time taken by a 7 bit adder and time taken by the (m−1) multiplexers to identify and provide the output based on the carry bit of the preceding adder block.

In another embodiment, the time taken by the n bit adder can be reduced by predicting the value of the carry bit of the preceding adder block. To predict the carry bit, the most significant bits (MSB) of both the binary inputs of each adder block are verified, if both the MSB are equal to ‘0’ then the carry bit will be a zero, and the multiplexer of the successive adder block can provide the output without waiting for the preceding adder block to generate the carry bit. For example, if both binary inputs A₆ (225₆) and B₆ (225₆) of the adder block 805₁ are zeros, the adder block 805₂ can provide the output at the same time as the adder block 805₁. Thus, if all of the MSB inputs of all of the adder blocks are zero then the time taken to generate the output of the n-bit adder can be reduced significantly to the time taken to generate the output of a 7-bit adder. In one embodiment, the n-bit incrementer, n-bit negater and the n-bit adder can be implemented both for computing the arithmetic operations in both the zero predictor and the arithmetic unit.

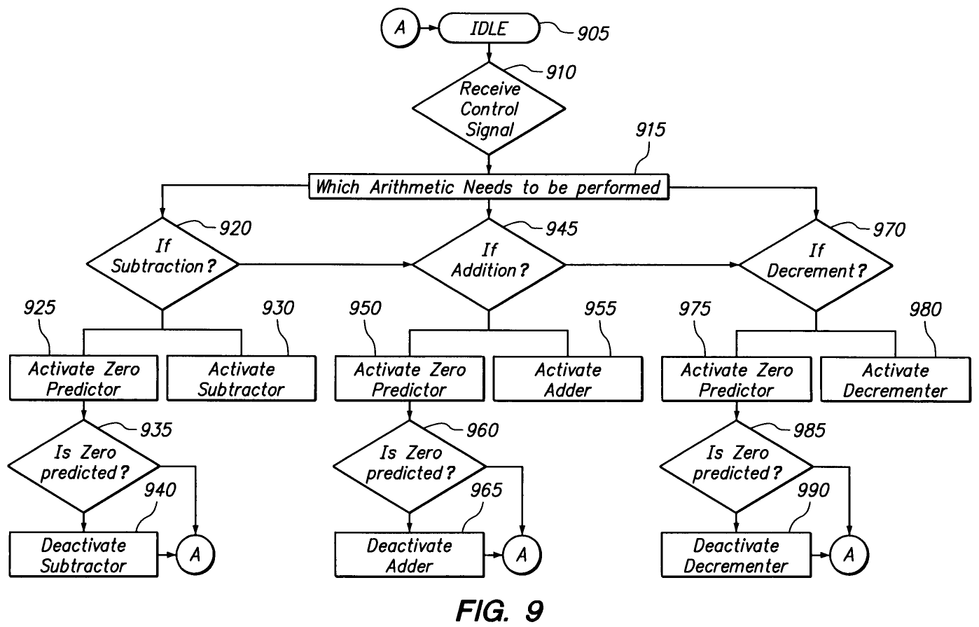

FIG. 9 is a flow chart of the method of the invention. The method is accomplished in operation of the controller 110 of the arithmetic logic unit 105. The controller 110 operates in the idle state on receiving power (step 905). The controller 110 verifies if it received a control signal to initiate the arithmetic operation (step 910), and if the control signal is not received, the controller returns to the idle state, otherwise the controller 110 determines which arithmetic operation needs to the performed. If the controller 110 determines that the difference of two binary numbers need to be calculated (step 920), it activates the zero predictor 110 and the arithmetic unit to perform subtraction using the control signals cntrl_1 155 and cntrl_2 150 respectively (step 925 and step 930). The zero predictor determines if the difference of the two binary inputs will result in a zero output or not by using the zero signal 160. Then controller 110 verifies to determine if the zero output is predicted (step 935), controller 110 then commands the arithmetic unit to halt the subtraction (step 940) and returns to idle state, otherwise, the arithmetic unit completes calculating the difference of two inputs and returns to idle state.

If the controller 110 determines that the sum of two binary numbers need to be calculated instead of the difference (step 945), it activates the zero predictor 110 and the arithmetic unit to perform addition using the control signals cntrl_1 155 and cntrl_2 150 respectively (step 950 and step 955). The zero predictor determines if the sum of the two binary inputs will result in a zero output or not by using the zero signal 160. Then controller 110 verifies to determine if the zero output is predicted (step 960), controller 110 then commands the arithmetic unit to halt the addition (step 965) and returns to idle state, otherwise, the arithmetic unit completes calculating the sum of two inputs and returns to idle state. If the controller 110 determines that a binary number need to be incremented instead of the calculating the sum or difference (step 970), it activates the zero predictor 110 and the arithmetic unit to increment the binary input using the control signals cntrl_1 155 and cntrl_2 150 respectively (step 975 and step 980). The zero predictor 115 will then notify the controller 110 whether incrementing the binary input will result in a zero output or not using the zero signal 160. The controller 110 verifies to determine if the zero output is predicted (step 985), then it commands the arithmetic unit to halt the arithmetic operation (step 990) and returns to idle state, otherwise, the arithmetic unit completes the arithmetic operation and returns to idle state.

While a specific multicore method for an eight point FFT computation has been discussed herein, it will be apparent to those familiar with the art that the same method can be extended to transform input data (time domain data) comprising more than eight points. The method is not limited to implementation on one multiple core processor array chip, and with appropriate circuit and software changes, it may be extended to utilize, for example, a multiplicity of processor arrays. It is expected that there will be a great many applications for this method which have not yet been envisioned. Indeed, it is one of the advantages of the present invention that the inventive method may be adapted to a great variety of uses.

The multicore method discussed above is only one example of available embodiments of the present invention. Those skilled in the art will readily observe that numerous other modifications and alterations may be made without departing from the spirit and scope of the invention. Accordingly, the disclosure herein is not intended as limiting and the appended claims are to be interpreted as encompassing the entire scope of the invention.

### INDUSTRIAL APPLICABILITY

The inventive zero predictor 115, arithmetic unit 120, controller 110, instruction set and method of FIG. 9 are intended to be widely used in a great variety of computer applications. It is expected that they will be particularly useful in applications where significant computing power and speed is required.

As discussed previously herein, the applicability of the present invention is such that the inputting information and instructions are greatly enhanced, both in speed and versatility. Also, communications between a computer array and other devices are enhanced according to the described method and means. Since the inventive zero predictor 115, arithmetic unit 120, controller 110, instruction set and method of FIG. 9 of the present invention may be readily produced and integrated with existing tasks, input/output devices and the like, and since the advantages as described herein are provided, it is expected that they will be readily accepted in the industry. For these and other reasons, it is expected that the utility and industrial applicability of the invention will be both significant in scope and long-lasting in duration.

1. A zero result predictor for predicting when the sum and carry of two binary numbers, A and B is equal to zero, comprising: a series of 7 bit comparators blocks connected in parallel to compare the binary value of number A with the binary value of number B.

2. A zero result predictor for predicting when the sum and carry of two binary numbers, A and B is equal to zero as in claim 1, wherein the series of 7 bit comparators blocks are connected in parallel to compare the value of the binary number A and B has the binary value of one.

3. A zero result predictor for predicting when the sum and carry of two binary numbers, A and B is equal to zero as in claim 1, further comprising: a series of 7 bit inverter blocks connected in parallel to generate an inverted binary value of one of the binary number A; and a second series of 7 bit incrementer blocks connected in parallel to generate a two's complement value of the binary number A; and a third series of 7 bit comparators blocks connected in parallel to compare the two's complement value of the binary number A with the binary B.

4. A method of predicting zero on a plurality of binary inputs, comprising the steps of identifying the arithmetic operation to be performed on the binary inputs, and, comparing the binary value of one input to the binary value of the other input upon the identification of an arithmetic operation.

5. A method of predicting zero on a plurality of binary inputs as in claim 4, wherein the arithmetic operation identified is subtraction.

6. A method of predicting zero on a plurality of binary inputs as in claim 4, wherein the comparing step is carried out by using a series of 7-bit comparators.

7. A method of predicting zero on a plurality of binary inputs as in claim 4, wherein the arithmetic operation to be performed is decrementing a binary input, and wherein the comparing step is carried out by using a series of 7-bit comparators.

8. A method of predicting zero on a plurality of binary inputs as in claim 4, wherein the arithmetic operation to be performed is addition, and wherein the negative value of the binary input is obtained by using a series of 7-bit inverters, and, 7-bit incrementers and the comparing step is carried out by a series of 7-bit comparators.
